(19) United States
(12) Patent Application Publication
(10) Pub. No.: US 2008/0242577 A1
(43) Pub. Date: Oct. 2, 2008

(54) Clear Rinsing Agent Containing Hydrophobically Modified Polycarboxylates

(75) Inventors: Heike Becker, Mannheim (DE); Stephan Nied, Neustadt/Wstr. (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Basf Aktiengesellschaft, Ludwigshafen (DE)

(21) Appl. No.: 11/573,450

(22) PCT Filed: Sep. 12, 2005
(86) PCT No.: PCT/EP05/09789

§ 371 Date: Jan. 9, 2008

(30) Foreign Application Priority Data
Sep. 14, 2004 (DE) 10 2004 044 402.1

(51) Int. Cl. C11D 3/37; C11D 3/16

(52) U.S. Cl. 510/230; 510/220

(57) ABSTRACT

Rinse agent formulations for machine dishwashing, comprising as components:
a) 1% to 20% by weight of copolymers of
   a1) 20% to 80% by weight of at least one monomer from the group consisting of monoethylenically unsaturated C₃-C₁₀ monocarboxylic or dicarboxylic acids or their anhydrides,
   a2) 10% to 80% by weight of at least one monomer of the general formula (I)

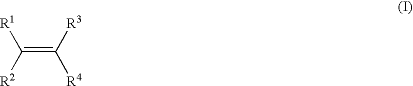

in which R¹, R² and R³ independently of one another are H, CH₃ or C₂H₅,
R⁴ is a linear, branched or cyclic radical having 1 to 6 carbon atoms or an aromatic radical having 6 to 12 carbon atoms, and
a3) 0% to 80% by weight of at least one further monomer, selected from the group consisting of olefins having 10 or more carbon atoms or mixtures thereof and reactive polyisobutenes having on average 12 to 100 carbon atoms,
b) 1% to 30% by weight of low-foaming nonionic surfactants,
c) 0% to 50% by weight of nonaqueous solvents,
d) 0% to 15% by weight of solubilizers,
e) 0% to 15% by weight of acidifiers,
f) 0% to 10% by weight of one or more further additives such as anionic, cationic, zwitterionic and amphoteric surfactants, dyes, fragrances and corrosion inhibitors;
g) water to 100% by weight.

The invention relates to rinse agents for machine dishwashing.

In the course of the wash cycle in the washing of dishware in a dishwasher it is freed of the soil, which is composed of a wide variety of food residues, including fatty and oily constituents. The detached soil particles and components are pumped around in the machine's wash water in the course of further washing. Before the clear-rinse cycle a large part of the water is replaced. A relatively small amount fraction of the water with the soil dispersed in it, however, remains in the clear-rinse cycle, and with the water introduced additionally, unless an ion exchanger is used, new hardness ions may be introduced into the machine.

The rinse aid is normally metered automatically after the main wash program. Another possibility is to use what are called 2-in-1 or 3-in-1 systems. In these systems the components which are needed for the clear-rinse cycle and are integrated in the detergent, in the form for example of a rinse agent core in the detergent tablet, are introduced into the machine with the detergent formulation right at the beginning of the wash cycle, and the components needed for the clear-rinse cycle are carried over into that cycle.

In the clear-rinse cycle the aim is to ensure that, in the course of drying, the water runs flatly and as far as possible without residue from the ware and that the ware surfaces at the end of the wash program are free from residue and gleam immaculately.

If, however, in the clear-rinse cycle the soil residues that are likewise carried over are not sufficiently dispersed and emulsified, they may deposit again on the ware. This is accompanied by unattractive deposits and filming on the surfaces. Moreover, the thin deposits of soil constituents may adversely affect the runoff characteristics in the clear-rinse cycle on these surfaces, with the consequence of increased spotting. By this is meant that water, instead of running quickly as a film from the dishware, leaves drops which, after drying, result in spotting and streaking. These spots and streaks may on the one hand be composed of soil residues. On the other hand it is possible, additionally, for drying residues to occur as a result of water hardness.

U.S. Pat. No. 5,739,099 discloses rinse agent formulations which comprise nonionic surfactants, hydrotropes and copolymers of allyl alcohol alkoxylates and acrylic acid.

EP-A 0 851 021 discloses rinse agent formulations which comprise low-foaming nonionic surfactants, hydrotropes, polycarboxylates and phosphate esters. Polycarboxylates specified include homopolymers or copolymers of acrylic acid, methacrylic acid, maleic acid, fumaric acid and itaconic acid.

DE-A 195 32 542 discloses rinse agents which comprise nonionic surfactants, organic carboxylic acids and certain cationic polymers.

DE-U 200 19 913 discloses rinse agents which comprise nonionic surfactants, solvents, hydrotropes, acidifiers and copolymers of unsaturated carboxylic acids and monomers containing sulfonic acid groups.

There is therefore a need for polymers which on the one hand, like a simple polycarboxylate customary in dishwashing, are capable of dispersing insoluble salts of metal ions which give rise to water hardness (calcium and magnesium ions). In addition, however, the polymers ought also to be capable of effectively dispersing or emulsifying the soil which is customary during dishwashing.

It is an object of the invention to provide rinse agent formulations which in machine dishwashing result in spotless and deposit-free dishware.

This object is achieved by means of rinse agent formulations for machine dishwashing, comprising as components:
a) 1% to 20% by weight of copolymers of
   a1) 20% to 80%, preferably 30% to 70%, by weight of at least one monomer from the group consisting of monoethylenically unsaturated C₃-C₁₀ monocarboxylic or dicarboxylic acids or their anhydrides,
   a2) 10% to 80%, preferably 10% to 50%, by weight of at least one monomer of the general formula (I)

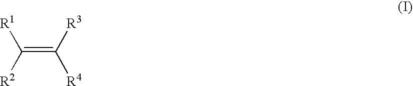

in which R¹, R² and R³ independently of one another are H, CH₃ or C₂H₅,
R⁴ is a linear, branched or cyclic radical having 1 to 6 carbon atoms or an aromatic radical having 6 to 10 carbon atoms, and
a3) 0% to 80%, preferably 5% to 20%, by weight of a further monomer, selected from the group consisting of olefins having 10 or more carbon atoms or mixtures thereof and reactive polyisobutenes having on average 12 to 100 carbon atoms,
b) 1% to 30%, preferably 5% to 15%, by weight of low-foaming nonionic surfactants,
c) 0% to 50%, preferably 5% to 40%, by weight of nonaqueous solvents,
d) 0% to 15%, preferably 1% to 10%, by weight of solubilizers,
e) 0% to 15%, preferably 1% to 10%, by weight of acidifiers,
f) 0% to 10% by weight of one or more further additives such as anionic, cationic, zwitterionic and amphoteric surfactants, dyes, fragrances and corrosion inhibitors;
g) water to 100% by weight.

Said object is further achieved through the use of copolymers a) as defined above in rinse agents for machine dishwashing for the purpose of reducing spotting and deposition.

It has been found that the hydrophobically modified polycarboxylates used in accordance with the invention significantly enhance the wash outcome. Lower filming and deposition and also improved runoff characteristics are found. The polycarboxylates in question additionally include hydrophobic monomers. While the usual polyacrylates, such as polyacrylate homopolymer or maleic acid-acrylic acid copolymers, also disperse water hardness very effectively, their interaction with the typical soil which arises in the course of machine dishwashing is minimal. The copolymers used in accordance with the invention assist the dispersion of dirt during machine dishwashing, thereby reducing filming and deposition. In addition said polymers assist the dispersion of water-insoluble salts present either in the wash water or in the food residues. These salts are, for example, calcium or magnesium carbonates or phosphates.

The rinse agent formulations of the invention can be used both for household applications and for industrial applications. The composition of the detergent is irrelevant in this context. Both phosphate-based systems and phosphate-free detergents can be used in combination with the rinse aid formulations. The rinse aid formulations themselves may also be part of a dishwasher detergent formulation.

Suitable monomers a1) are for example maleic acid, maleic anhydride, acrylic acid, methacrylic acid, fumaric acid, itaconic acid and citraconic acid. Preferred copolymers a) comprise as monomers a1) monomers selected from the group consisting of maleic acid, maleic anhydride and acrylic acid.

Suitable monomers a2) are for example isobutene, diisobutene, butene, pentene, hexene and styrene. Further-preferred copolymers a) comprise as monomers a2) monomers selected from the group consisting of isobutene, diisobutene (2-methyl-3,3-dimethyl-1-butene) and styrene.

Suitable monomers a3) have at least 10, generally 10-26, carbon atoms. Suitable monomers a3) are for example 1-decene, 1-dodecene, 1-tetradecene, 1-hexadecene, 1-octadecene, 1-eicosene, 1-docosene, 1-tetracosene and 1-hexacosene. Further-preferred copolymers a) comprise as monomers a3) monomers selected from the group consisting of 1-dodecene, 1-octadecene, C₂₂ alpha-olefin, a mixture of C₂₀-C₂₄ alpha-olefins and polyisobutene having on average 12 to 100 carbon atoms.

With particular preference copolymers a) comprise not only monomers a1) selected from maleic acid, maleic anhydride and acrylic acid but also monomers a2) selected from isobutene, diisobutene and styrene and monomers a3) selected from the group consisting of 1-dodecene, 1-octadecene, C₂₂ alpha-olefin, a mixture of C₂₀-C₂₄ alpha-olefins and polyisobutene having on average 12 to 100 carbon atoms. Especial preference is given to copolymers of 30% to 70% by weight of maleic acid and maleic anhydride as monomers a1), 20% to 40% by weight of isobutene as monomer a2) and 5% to 20% by weight of octadecene as monomer a3).

As component b) the rinse agent formulations of the invention comprise low-foaming nonionic surfactants.

Suitable nonionic surfactants comprise the surfactants of the general formula (II)

R²—O—(CH₂CH₂O)ₚ—(CHR¹CH₂O)ₘ—R³ (II)

in which R² is a linear or branched alkyl radical having 8 to 22 carbon atoms, R¹ and R³ independently of one another are hydrogen or a linear or branched alkyl radical having 1-10 carbon atoms or are H, R¹ preferably being methyl, and p and m independently of one another are 0 to 300. Preferably p=1-50 and m=0-30.

The surfactants of the formula (II) may be both random copolymers and block copolymers; preferably they are block copolymers.

In addition it is possible to use diblock and multiblock copolymers constructed from ethylene oxide and propylene oxide, these copolymers being available commercially, for example, under the designation Pluronice® (BASF Aktiengesellschaft) or Tetronic® (BASF Corporation). In addition it is possible to use reaction products of sorbitan esters with ethylene oxide and/or propylene oxide. Likewise suitable are amine oxides or akylglycosides. An overview of suitable nonionic surfactants is given by EP-A 851 023 and by DE-A 198 19 187.

Further suitable nonionic surfactants which can be used additionally are alkylglycosides, amine oxides, fatty acid alkanolamides and polyhydroxy-fatty acid amides, as described for example in DE-U 200 19 913.

U.S. Pat. Nos. 4,366,326; 4,624,803; 4,280,919; 4,340,766; 3,956,401; 5,200,236; 5,425,894 and 5,294,365 describe in detail suitable low-foaming nonionic surfactants which can be used as component (a) in the rinse agent formulations of the invention, as does Surfactants Science Series, edited by Martin J. Schick, Nonionic Surfactants, Vols. 19 and 23.

As component c) the rinse agent formulations of the invention comprise nonaqueous solvent.

Suitable nonaqueous solvents are monohydric or polyhydric alcohols, alkanolamines or glycol ethers, preferably ethanol, n-propanol, isopropanol, 1-butanol, 2-butanol, ethylene glycol, propanediol, butanediol, glycerol, diglycol, propyldiglycol, butyldiglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl ether or ethyl ether, methoxy-, ethoxy- or butoxytriglycol, 1-butoxyethoxy-2-propanol, 3-methyl-3-methoxybutanol, propylene glycol t-butyl ether, and mixtures of 2 or more of these solvents.

As component d) the rinse agent formulations of the invention comprise solubilizers (hydrotropes).

Suitable solubilizers are mono- to penta-C₁-C₅ alkyl-substituted benzenesulfonates such as toluene-, cumene- or xylenesulfonate, dihexylsulfosuccinate and short-chain alkyl sulfates. Suitable solubilizers are described in U.S. Pat. No. 3,563,901 and U.S. Pat. No. 4,443,270.

As component e) the rinse aid formulations of the invention comprise acidifiers.

Suitable acidifiers are organic or inorganic acids, preferably solid monocarboxylic, oligocarboxylic or polycarboxylic acids or sulfonic acids, examples being citric acid, tartaric acid, succinic acid, malonic acid, adipic acid, maleic acid, fumaric acid, oxalic acid, polyacrylic acid and amidosulfonic acid and also mixtures thereof, one example being a mixture of succinic acid, glutaric acid and adipic acid that is available under the tradename Sokalan® DCS from BASF AG.

As component f) the rinse aid formulations of the invention may comprise further additives, such as anionic, cationic, zwitterionic or amphoteric surfactants, dyes, fragrances and corrosion inhibitors.

Examples of suitable anionic surfactants include sodium or potassium alkyl sulfates, particularly those obtained by sulfating C₈-C₁₈ alcohols, such as those obtained from glycerides of tallow oil or coconut oil. Further examples are sodium and potassium alkylbenzenesulfonates having 9 to 15 carbon atoms in the alkyl chain, particular preference being given to the linear alkylbenzenesulfonates having 11 to 13 carbon atoms in the alkyl group.

Further suitable anionic surfactants are alkyl glyceryl ether sulfonates, particularly those of ethers of higher alcohols, such as may be obtained from tallow oil or coconut oil, and also sulfonates and sulfates of coconut oil fatty acid monoglycerides, alkylphenol ether sulfates having 1 to 10 ethylene oxide units and 8 to 12 carbon atoms in the alkyl group, alkyl ether sulfates having 1 to 25 ethylene oxide units and 10 to 20 carbon atoms in the alkyl group, and also α-sulfonated fatty acid esters having 6 to 20 carbon atoms in the fatty acid alkyl group and 1 to 10 carbon atoms in the ester group, and 2-acyloxyalkanesulfonic acids containing 9 to 23 carbon atoms in the alkyl group and 8 to 20 carbon atoms in the acyl group.

Particularly preferred anionic surfactants are the alkali metal salts of C₁₁-C₁₃ alkyl-benzenesulfonates, C₁₂-C₁₈ alkyl sulfates and C₁₂-C₁₈ alkyl ether sulfates containing 1 to 10 mol of ethylene oxide.

Further suitable anionic surfactants too are the sulfosuccinates, which are monoesters and/or diesters of sulfosuccinic acid with fatty alcohols or ethoxylated fatty alcohols. Preferred sulfosuccinates contain C₈-C₁₈ fatty alcohol residues. Suitable anionic surfactants also include soaps, examples being the salts of lauric acid, myristic acid, palmitic acid, stearic acid, of hydrogenated erucic acid and behenic acid, and also soap mixtures derived from natural fatty acid mixtures, coconut, palm kernel or tallow fatty acid for example.

The anionic surfactants, including the soaps, can be present in the form of their sodium, potassium or ammonium salts and as soluble salts of organic bases, such as mono-, di- or triethanolamine, and are preferably in the form of their sodium or potassium salts, especially in the form of the sodium salts.

The invention is illustrated by the examples below.

### EXAMPLES

In order to test the clear-rinse effect the copolymers under test were mixed into a rinse aid formulation. The test was carried out under the stated conditions at 3° dH [German hardness] and with the addition of IKW ballast soil, in accordance with SÖFW Journal, Volume 124, 14/98, p.1029, in the main wash cycle and clear-rinse cycle.

The detergent used was the following formulation:
50% by weight sodium tripolyphosphate (Na₃P₃O₁₀.6 H₂O)
27% by weight sodium carbonate
3% by weight sodium disilicate (x Na₂O.y SiO₂; x/y=2.65; 80% form)
6% by weight sodium percarbonate (Na₂CO₃.1.5 H₂O)
2% by weight tetraacetylenediamine (TAED)
2% by weight low-foam nonionic surfactant based on fatty alcohol alkoxylates
3% by weight low-foam nonionic surfactant based on fatty alcohol alkoxylates
5% by weight sodium sulfate
2% by weight polyacrylic acid sodium salt (M_{w} 8000)

The (co)polymer was used in the following rinse aid formulation:
20% by weight low-foam nonionic surfactant based on fatty alcohol alkoxylates
10% by weight hydrotrope (cumenesulfonate)
5% by weight isopropanol
4% by weight copolymer
61% by weight water

Copolymers 1-3 below were tested.

Polymer 1: Copolymer of maleic acid and diisobutene (weight ratio 51:49) having a molecular weight of 12 000 g/mol;

Polymer 2: Copolymer of maleic anhydride, isobutene and C18 olefin (weight ratio 65:26:9), molecular weight 3000 g/mol;

Polymer 3: Copolymer of maleic acid and isobutene (weight ratio 68:32) having a molecular weight of 4000 g/mol.

The wash tests were carried out under the following conditions:
Dishwasher: Miele G 686 SC
Wash cycles: 1 wash cycle 55° C. normal (without prerinse)
Ware: knife (WMF table knife Berlin, monobloc); glasses (Willy Becher, 0.3 I); black plastic plates, black side plates; EMSA Superline box (lid blue PE, body transparent PP)
Detergent: 21 g
Ballast soil 50 g in main wash; 2 g in clear-rinse
Clear-rinse temperature: 65° C.
Rinse aid metering: 1 g
Water hardness: 3° dH (German hardness, corresponding to 53 mg of CaCO₃/kg of water)

After the end of the wash cycle the door was opened and the ware was left to dry for 60 minutes with the machine door open. The ware was subsequently evaluated by visual inspection in a light box which had a black coating and was fitted with a halogen spotlight and a perforated plate, using a rating scale from 0 (very poor, very severe filming; very severe spotting, more than 50% of the surface covered with spots) to 4 (very good, no filming, no spots).

The results are summarized in the table below.

TABLE
Wash results

| | Dishware (average) | Plastic (average) |
|---|---|---|
| No polymer | 2.4 | 0.8 |
| Polymer 1 | 3.3 | 1.5 |
| Polymer 2 | 3.4 | 1.2 |
| Polymer 3 | 2.7 | 1.3 |

1. A rinse agent formulation comprising:
a) 1% to 20% by weight of copolymers of
a1) 30% to 70% by weight of at least one monomer selected from the group consisting of maleic anhydride, acrylic acid, methacrylic acid, fumaric acid, itaconic acid and citraconic acid,
a2) 10% to 50% by weight of at least one monomer, selected from the group consisting of isobutene, diisobutene, butene, pentene, hexene and styrene,
a3) 5% to 20% by weight of at least one further monomer, selected from the group consisting of 1-decene, 1-dodecene, 1-tetradecene, 1-hexadecene, 1-octadecene, 1-eicasene, 1-docosene, 1-tetracosene, 1-hexacosene and polyisobutene and reactive polyisobutenes, having an average 12 to 100 carbon atoms,
b) 1% to 30% by weight of low-foaming nonionic surfactants,
c) 0% to 50% by weight of nonaqueous solvents,
d) 0% to 15% by weight of solubilizers,
e) 0% to 15% by weight of acidifiers,
f) 0% to 10% by weight of one or more further additives such as anionic, cationic. zwitterionic and amphoteric surfactants, dyes, fragrances and corrosion inhibitors,
g) water to 100% by Weight.

2. The rinse agent formulation according to claim 1, wherein in the copolymer a) the monomers a1) are selected from the group consisting of maleic acid, maleic anhydride and acrylic acid, the monomers a2) are selected from the group consisting of isobutene, diisobutene and styrene, and the monomers a3) are selected from the group consisting of 1-dodecene, 1-octadecene, C₂₂ alpha-olefin, a mixture of C₂₀-C₂₄ alpha-olefins and polyisobutene having on average 12 to 100 carbon atoms.

3. A method for reducing spotting and deposition on dishware in machine dishwashing, comprising the step of adding copolymers a) as defined in claim 1 to rinse agent or detergent for formulations for machine dishwashing.

4. (canceled)
